(19) United States
(12) Patent Application Publication
(10) Pub. No.: US 2020/0134924 A1
(43) Pub. Date: Apr. 30, 2020

(54) APPARATUS AND METHOD FOR OBJECT NETWORKING

(71) Applicant: ELECTRONICS AND TELECOMMUNICATIONS RESEARCH INSTITUTE, Daejeon (KR)

(72) Inventors: Tae-Yeon KIM, Daejeon (KR); Bhum-Cheol LEE, Daejeon (KR); Ho-Yong RYU, Daejeon (KR); Pyung-Koo PARK, Daejeon (KR); Sung-Hyun YOON, Daejeon (KR); Ho-Sun YOON, Daejeon (KR); Sung-Back HONG, Daejeon (KR); Jung-Yeon HWANG, Daejeon (KR)

(73) Assignee: ELECTRONICS AND TELECOMMUNICATIONS RESEARCH INSTITUTE, Daejeon (KR)

(21) Appl. No.: 16/664,156

(22) Filed: Oct. 25, 2019

(30) Foreign Application Priority Data
Oct. 26, 2018 (KR) 10-2018-0129318
Oct. 15, 2019 (KR) 10-2019-0127754

(51) Int. Cl. G06T 19/00; G02B 27/01; G06F 3/01; H04L 29/08; G06F 3/0481

(52) U.S. Cl. CPC G06T 19/006; G02B 27/017; G06F 3/011; G06F 3/017; G02B 2027/0138; H04L 67/2842; G06F 3/04815; G02B 2027/014; H04L 67/327

(57) ABSTRACT

Disclosed herein are an apparatus and method for object networking. The apparatus includes one or more processors and executable memory for storing at least one program executed by the one or more processors. The at least one program registers a real object included in the scene recognized by the virtualization display device of a user as an object of interest, generates a local network using local information pertaining to the object of interest, and generates a global network of multiple objects of interest from the local networks of the multiple objects of interest using global information pertaining to the object of interest.

### CROSS REFERENCE TO RELATED APPLICATIONS

This application claims the benefit of Korean Patent Application No. 10-2018-0129318, filed Oct. 26, 2018, and No. 10-2019-0127754, filed Oct. 15, 2019, which are hereby incorporated by reference in their entireties into this application.

### BACKGROUND OF THE INVENTION

### 1. Technical Field

The present invention relates generally to technology for object networking in augmented/virtual reality, and more particularly to technology for configuring a network between objects included in a scene shown to a subject in augmented/virtual reality.

### 2. Description of the Related Art

Recently, the computer vision field has greatly improved thanks to mobility and intelligence, the levels of which have been sharply increased with the rapid improvement of Artificial Intelligence (AI). Also, intelligence based on AI and mobility combined with mobile communication have led to the expansion of application fields of systems and devices using Augmented Reality (AR), Virtual Reality (VR), 3D cameras, 3D glasses, or 3D goggles.

For application to mobility and autonomy, various methods for replacing icons of smartphones in AR/VR glasses are proposed. As an art related thereto, U.S. Patent Application Publication No. US2018/0150204, filed by Google and titled “Switching of active objects in an augmented and/or virtual reality environment”, discloses a virtual-reality system that configures a screen based on an eye gaze direction and movement of a user in order to replace icons, a keyboard, and a mouse when the user interacts with objects and functions in a virtual environment.

Meanwhile, U.S. Pat. No. 9,965,899, filed by Verizon and titled “Methods and systems for minimizing pixel data transmission in a network-based virtual reality media delivery configuration”, relates to a method and system for providing virtual reality based on a network, and discloses a method for providing scenes to VR glasses over a network.

Also, U.S. Patent Application Publication No. US2017/0221158, filed by Facebook and titled “Computer-vision content detection for connecting objects in media to users” discloses a method, apparatus and system for inferring the properties of media (a location, time, and the like) and social-network users by detecting objects in image content uploaded by a user.

As shown in the related arts described above, computer vision, AI, and the spread of broadband/low-latency mobile communication are completely changing paradigms of person-to-person and person-to-machine communication methods, and communication of everything is evolving beyond a static and predefined state. The present invention proposes a method for providing a network between objects included in a scene viewed through a camera, AR/VR glasses, or the like and information thereabout in real time in order to enable transmission and reception of new information about the objects included in the scene.

### SUMMARY OF THE INVENTION

An object of the present invention is to configure a network between objects in augmented/virtual reality.

Another object of the present invention is to provide virtualization, networking, and configuration of the most recent information in order to deliver information about objects to a subject (user).

A further object of the present invention is to provide global information on objects, communication therebetween, real-time information related to the objects, and an environment in which real-time interaction with the objects is possible.

In order to accomplish the above objects, an apparatus for object networking according to an embodiment of the present invention includes one or more processors and executable memory for storing at least one program executed by the one or more processors. The at least one program may register a real object, included in a scene recognized by a virtualization display device of a user, as an object of interest, generate a local network using local information pertaining to the object of interest, and generate a global network of multiple objects of interest from the local networks of the multiple objects of interest using global information pertaining to the object of interest.

Here, the at least one program may set at least one object of interest included in the scene and the virtualization display device as virtual entities included in the scene.

Here, the at least one program may generate a virtualized space corresponding to the scene, set the virtual entities in the virtualized space, and configure a virtual network for the virtual entities set in the virtualized space, thereby generating the local network.

Here, the at least one program may set the virtual entity by mapping the object of interest to a virtual object in a logical domain, and may provide information about the virtual object to the virtualization display device using a virtual network connected with the virtual object in the logical domain when the object of interest is not connected with a physical network.

Here, the at least one program may transmit the information about the virtual object by mapping the virtual object, corresponding to the object of interest, to a packet of interest using a Named-Data Networking (NDN) method related to Information-Centric Networking (ICN) in a network that connects a virtualization and networking layer with a local metadata layer.

Here, the at least one program may register the real object, at which the user gazes through the virtualization display device for a preset time, as the object of interest.

Here, the at least one program may cancel registration as the object of interest and change the real object to an object not of interest when an interval at which the object of interest appears in the scene is greater than a preset time.

Here, the at least one program may request the local information pertaining to the object of interest from a local metadata layer and forward a request for the local information from a first node in the local metadata layer, which receives the request for the local information, to a second node in the local metadata layer when the local information is not present in the first node, thereby acquiring the local information pertaining to the object of interest.

Here, the second node in the local metadata layer may request the global information pertaining to the object of interest from a global repository layer and forward a request for the global information from a first node in the global repository layer, which receives the request for the global information, to a second node in the global repository layer when the global information is not present in the first node in the global repository layer, thereby acquiring the global information pertaining to the object of interest.

Also, in order to accomplish the above objects, a method for object networking, performed by an apparatus for object networking, according to an embodiment of the present invention includes registering a real object, included in a scene recognized by a virtualization display device of a user, as an object of interest; generating a local network using local information pertaining to the object of interest; and generating a global network of multiple objects of interest from the local networks of the multiple objects of interest using global information pertaining to the object of interest.

Here, generating the local network may be configured to set at least one object of interest included in the scene and the virtualization display device as virtual entities of the scene.

Here, generating the local network may be configured to generate a virtualized space corresponding to the scene, to set the virtual entities in the virtualized space, and to configure a virtual network for the virtual entities set in the virtualized space, thereby generating the local network.

Here, generating the local network may be configured to set the virtual entity by mapping the object of interest to a virtual object in a logical domain, and to provide information about the virtual object to the virtualization display device using a virtual network connected with the virtual object in the logical domain when the object of interest is not connected with a physical network.

Here, generating the local network may be configured to transmit the information about the virtual object by mapping the virtual object, corresponding to the object of interest, to a packet of interest using a Named-Data Networking (NDN) method related to Information-Centric Networking (ICN) in a network that connects a virtualization and networking layer with a local metadata layer.

Here, registering the real object as the object of interest may be configured to register the real object, at which the user gazes through the virtualization display device for a preset time, as the object of interest.

Here, the method may further include cancelling registration as the object of interest, and cancelling the registration as the object of interest may be configured to cancel the registration as the object of interest and change the real object to an object not of interest when an interval at which the object of interest appears in the scene is greater than a preset time.

Here, generating the local network may be configured to request the local information pertaining to the object of interest from a local metadata layer and to forward a request for the local information from a first node in the local metadata layer, which receives the request for the local information, to a second node in the local metadata layer when the local information is not present in the first node, thereby acquiring the local information pertaining to the object of interest.

Here, generating the global network may be configured to request the global information pertaining to the object of interest from a global repository layer and to forward a request for the global information from a first node in the global repository layer, which receives the request for the global information, to a second node in the global repository layer when the global information is not present in the first node in the global repository layer, thereby acquiring the global information pertaining to the object of interest.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that shows the recognition of a real object by a virtualization display device (AR/VR glasses) according to an embodiment of the present invention;

FIG. 2 is a view that shows a network between the real objects included in the first scene illustrated in FIG. 1;

FIG. 3 is a view that shows a network between the real objects included in the second scene illustrated in FIG. 1;

FIG. 4 is a view that shows a virtual network between the real objects included in the first scene illustrated in FIG. 2;

FIG. 5 is a view that shows a virtual network between the real objects included in the second scene illustrated in FIG. 3;

FIG. 6 is a view that shows a hierarchical structure of object-networking layers according to an embodiment of the present invention;

FIG. 7 is a view that shows a system for object networking according to an embodiment of the present invention;

FIG. 8 is a block diagram that shows an apparatus for object networking according to an embodiment of the present invention;

FIG. 9 is a block diagram that specifically shows an example of the virtualization and networking unit illustrated in FIG. 8;

FIG. 10 is a block diagram that specifically shows an example of the metadata provision unit illustrated in FIG. 8;

FIG. 11 is a block diagram that specifically shows an example of the global information provision unit illustrated in FIG. 8;

FIG. 12 is a flowchart that shows a method for object networking according to an embodiment of the present invention;

FIG. 13 is a flowchart that specifically shows an example of the step of registering an object of interest illustrated in FIG. 12;

FIG. 14 is a flowchart that specifically shows an example of the step of providing information about a network of objects of interest illustrated in FIG. 12;

FIG. 15 is a flowchart that specifically shows an example of the step of cancelling the registration as an object of interest illustrated in FIG. 12;

FIG. 16 is a view that shows an object-networking system that includes IoT devices as objects according to an embodiment of the present invention;

FIG. 17 is a view that shows the process of providing local information (metadata information) in an object-networking system according to an embodiment of the present invention;

FIG. 18 is a sequence diagram that shows the process of acquiring local information and global information in an object-networking method according to an embodiment of the present invention;

FIG. 19 is a view that shows the virtualization of a physical domain and the configuration of a virtual network according to an embodiment of the present invention;

FIG. 20 is a view that shows the virtualization of a physical domain including physical objects having the same name and the configuration of a virtual network according to an embodiment of the present invention; and

FIG. 21 is a view that shows a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present invention will be described in detail with reference to the accompanying drawings.

FIG. 1 is a view that shows the recognition of a real object by a virtualization display device (AR/VR glasses) according to an embodiment of the present invention.

Referring to FIG. 1, a physical domain according to the present invention may include physical entities and physical/virtual computers and networks for providing the physical entities with networking and information. Here, the physical entities include an AR/VR glasses device used for observing scenes in an environment (particularly an AR/VR environment), objects included in the scenes viewed by a subject, and a user (including a robot) that views the scenes through the AR/VR glasses device.

A logical domain according to the present invention includes a virtualization and networking layer for providing the virtualization of the AR/VR glasses device and the objects included in the scenes viewed through the AR/VR glasses device and a virtual network therebetween, a local metadata layer for providing the attributes of the AR/VR glasses device, the objects, and the virtual network and the relationships therebetween, and a global repository layer for enabling local information to be used in a global domain.

In the present invention, objects for which a virtual network and information are provided are defined as objects of interest. Also, objects for which neither a virtual network and nor information is provided are defined as objects of disinterest. Here, the virtual network means a logically configured network. The virtual network may be a VLAN, VXLAN, or the like, and may be an information-centric network. Here, the information may include attributes, characteristics and the like related to the objects.

FIG. 1 shows two scenes 101 and 102 that come into a first field of view and a second field of view, respectively, through a glasses device 103 worn by a user, which is an example of a virtualization display device, and real objects included in the scenes.

Here, the glasses device 103 may be an AR/VR glasses device, which is a virtualization display device that is capable of providing AR/VR applications.

Here, the real objects recognized in the two scenes 101 and 102 in the first and second fields of view of the glasses device 103 may be registered as objects of interest by an object-networking apparatus 100.

The objects A, B, C and D in the first scene 101 are registered as objects of interest for the first scene 101, and the objects D, E and F in the second scene 102 are registered as objects of interest for the second scene 102.

Here, the object D is included in both the first scene 101 and the second scene 102.

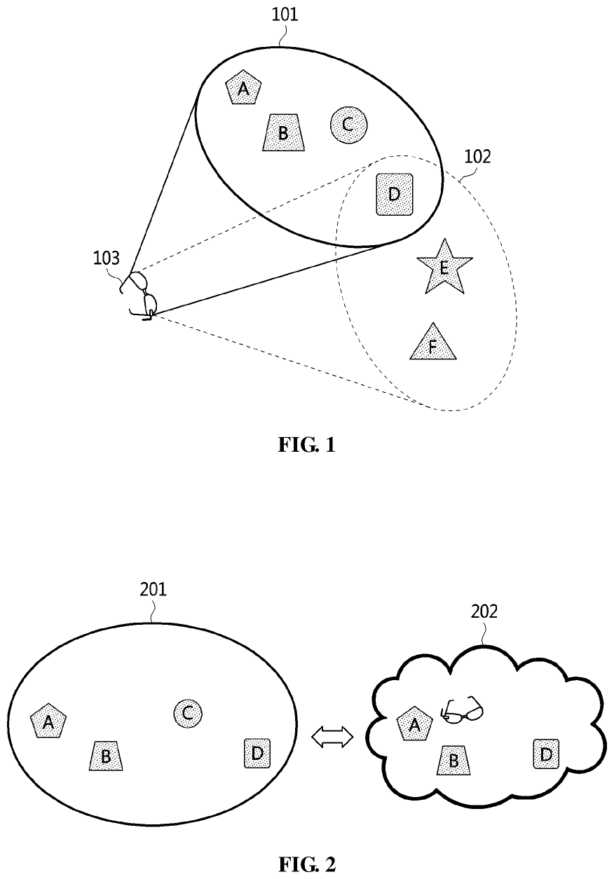

FIG. 2 is a view that shows a network of the real objects included in the first scene illustrated in FIG. 1.

FIG. 2 shows a physical network 202 for the objects of interest for the first scene 201, from which the object C is excluded.

Here, the object C is an object of interest that is physically present. However, because the object C is not physically connected with the network, the object C is excluded from the network 202.

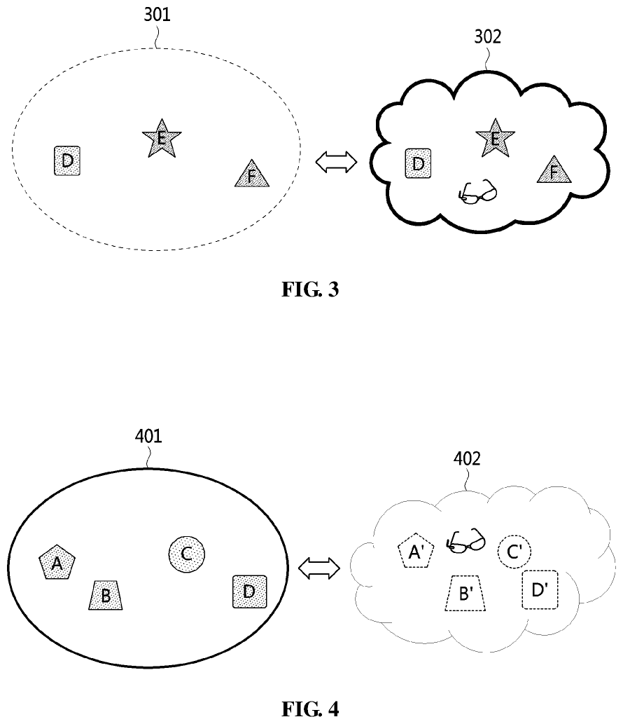

FIG. 3 is a view that shows a network of the real objects included in the second scene illustrated in FIG. 1.

Referring to FIG. 3, all of the objects of interest D, E and F are included in the network 302 configured for the second scene 301. Accordingly, it may be understood that all of the objects of interest D, E and F are connected with a physical network.

FIG. 4 is a view that shows a virtual network of the real objects included in the first scene illustrated in FIG. 2.

Referring to FIG. 4, the objects of interest A, B, C and D in the first scene 401 are virtualized into A′, B′, C′ and D′, respectively, and are connected with a first virtual network 402, and the glasses device 103 is also virtualized and connected with the first virtual network 402. Unlike what is shown in FIG. 2, the virtual object C′ may be connected with the first virtual network 402 although the object of interest C is not connected with a physical network.

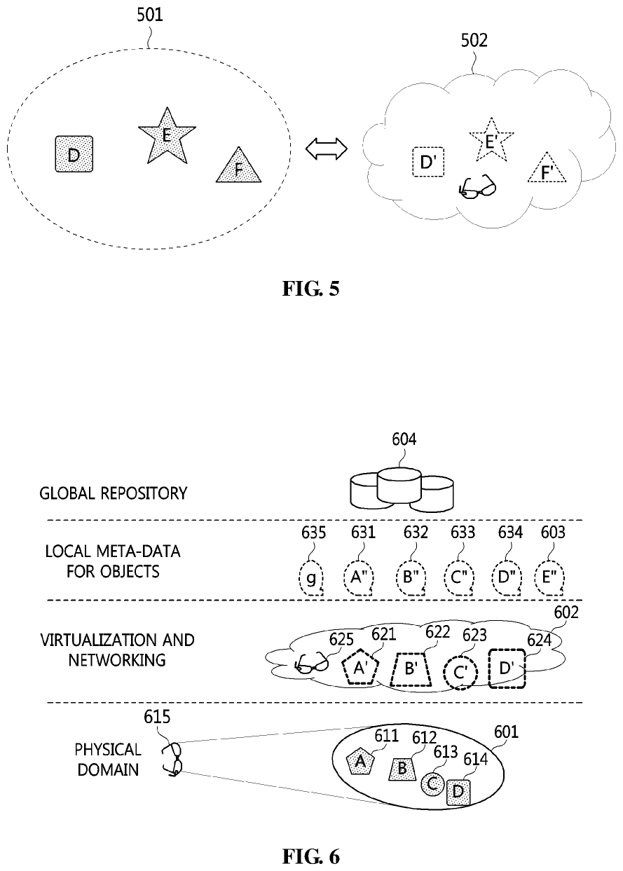

FIG. 5 is a view that shows a virtual network of the real objects included in the second scene illustrated in FIG. 3.

Referring to FIG. 5, the objects of interest D, E and F in the second scene 501 are virtualized into D′, E′ and F′, respectively, and the glasses device 103 is also virtualized. Then, the virtualized objects and the virtualized glasses device are connected with a second virtual network 502.

FIG. 6 is a view that shows the hierarchical structure of object-networking layers according to an embodiment of the present invention.

Referring to FIG. 6, the object-networking layers according to an embodiment of the present invention include a physical domain layer, a virtualization and networking layer, a local metadata layer, and a global repository layer.

The physical domain layer includes a glasses device 615 and objects A 611, B 612, C 613, and D 614, which are included in the scene 601 that comes into the field of view of the glasses device 615.

The virtualization and networking layer includes the glasses device 625 in the physical domain, virtual objects A′ 621, B′ 622, C′ 623, and D′ 624, which are acquired by virtualizing the objects in the physical domain, and a virtual network 602 connected with the virtual objects.

The local metadata layer includes a virtualized glasses device 635, virtualized objects A″ 631, B″ 632, C″ 633, and D″ 634, and virtual network information E″ 603, which is information about a virtual network between the virtualized glasses device 635 and the virtualized objects.

The global repository layer includes a global repository 604 for providing global information on objects.

Also, the respective layers illustrated in FIG. 6 may be connected with each other using any of various connection/communication methods.

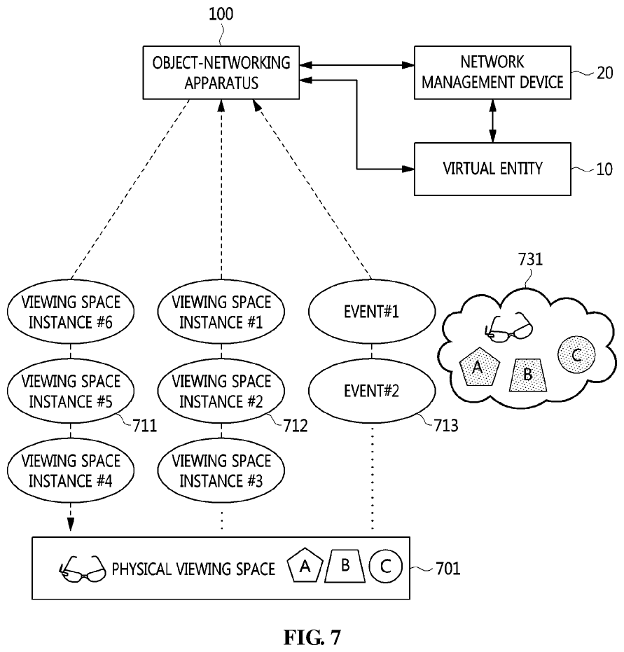

FIG. 7 is a view that shows a system for object networking according to an embodiment of the present invention.

Referring to FIG. 7, the object-networking system according to an embodiment of the present invention may include an object-networking apparatus 100, virtual entities 10, and a network management device 20.

A glasses device and objects 701 in a physical domain may be input to the object-networking apparatus 100 through scenes 712 containing the objects, which are viewed through the glasses device.

The object-networking apparatus 100 extracts objects that have been registered as objects of interest in advance or objects that are newly registered as objects of interest through an event 713 triggered by the eye gaze of a user, thereby generating virtual entities 10 from the extracted objects of interest and the glasses device in a virtualized space.

The virtual entities 10 may include a subject, which is a virtualized form of the glasses device, the objects of interest, and a virtual network.

The object-networking apparatus 100 may generate a single logical view network.

Here, the object-networking apparatus 100 may store the virtual subject, the objects of interest, and virtual network information, and may finally output scenes 711 containing the virtual space to a user through the glasses device, which is a virtualization display device, using a view-based application service.

The network management device 20 may manage the generation of virtual entities 10 and the lifecycle thereof, and may serve to generate and manage a virtual network 731, which is required for communication between the virtual entities 10.

Also, the object-networking apparatus 100 may store metadata for configuring a virtual view network.

Here, the object-networking apparatus 100 may store physical information and logical information about the subject and the objects, that is, scenes based on views recognized by the subject, information about the locations of the objects acquired from image information pertaining to the objects of interest and the subject, information about a communication network between the objects, and metadata, which is information about the attributes, performance, and the functionalities of the subject and objects.

Also, the object-networking apparatus 100 may provide a view-based application service by connecting a plurality of logical-domain view networks that are distributed.

Here, in order to run a view-based application service, the object-networking apparatus 100 may collect information about the objects of interest, included in the view network configured in each local domain, and information about a virtual network from a local metadata domain.

Then, the object-networking apparatus 100 may update the metadata information pertaining to the objects of interest, collected from each local metadata domain, and global connection information using the most recent local information.

Here, the object-networking apparatus 100 may generate a global network for providing a view-based application service by connecting the view networks in the local domains.

Here, the object-networking apparatus 100 may store information about the objects of interest and the virtual network, acquired from the view network in each local domain, the most recent metadata information related thereto, acquired from the global domain, and information required in order to configure a global network therebetween.

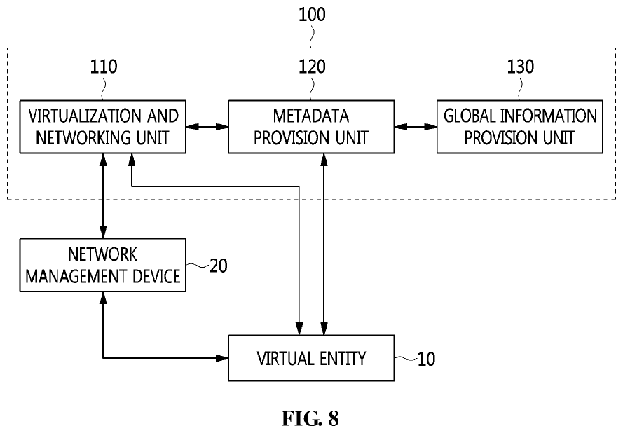

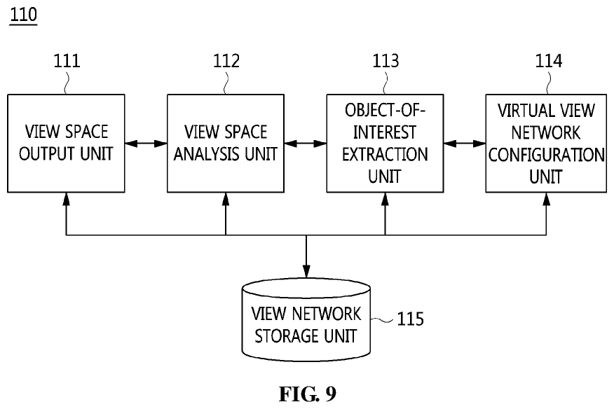

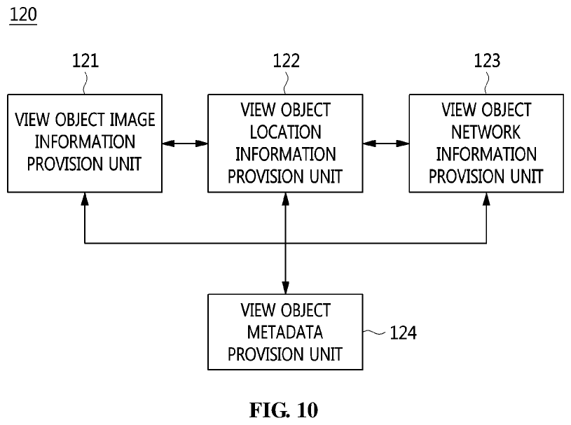

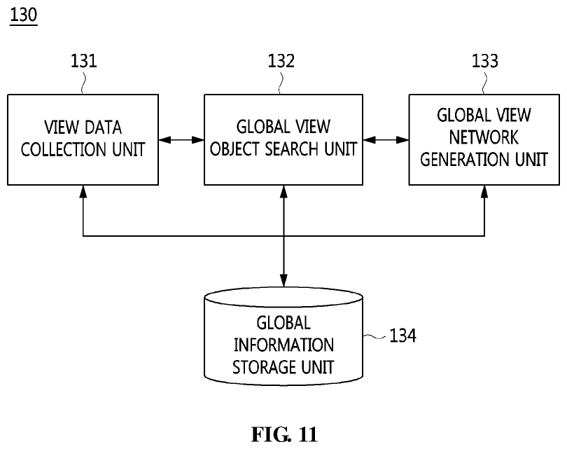

FIG. 8 is a block diagram that shows an apparatus for object networking according to an embodiment of the present invention. FIG. 9 is a block diagram that specifically shows an example of the virtualization and networking unit illustrated in FIG. 8. FIG. 10 is a block diagram that specifically shows an example of the metadata provision unit illustrated in FIG. 8. FIG. 11 is a block diagram that specifically shows an example of the global information provision unit illustrated in FIG. 8.

Referring to FIG. 8, the apparatus for object networking according to an embodiment of the present invention includes a virtualization and networking unit 110, a metadata provision unit 120, and a global information provision unit 130.

The virtualization and networking unit 110 may register a real object, included in the scene recognized by the virtualization display device of a user, as an object of interest.

The virtualization and networking unit 110 may register a real object as an object of interest when the user gazes at the real object through the virtualization display device for a preset time AT (AT being a real number that is equal to or greater than 0).

The metadata provision unit 120 may generate a local network using local information pertaining to the object of interest.

Here, the metadata provision unit 120 may set at least one object of interest included in a scene and the virtualization display device as virtual entities of the scene.

Here, the metadata provision unit 120 may generate a virtualized space for the scene, set the virtual entities in the virtualized space, and configure a virtual network for the virtual entities set in the virtualized space, thereby generating a local network.

Here, the metadata provision unit 120 may set the virtual entity by mapping the object of interest to a virtual object in a logical domain. Also, when the object of interest is not connected with a physical network, the metadata provision unit 120 may provide information about the virtual object, corresponding to the object of interest, to the virtualization display device using the virtual network connected with the virtual object in the logical domain.

Here, the metadata provision unit 120 may transmit the information about the virtual object by mapping the virtual object, corresponding to the object of interest, to a packet of interest using a Named-Data Networking (NDN) method related to Information-Centric Networking (ICN) in a network that connects the virtualization and networking layer with the local metadata layer.

The global information provision unit 130 may generate a global network of multiple objects of interest from the local networks of the multiple objects of interest using global information pertaining to the object of interest.

Also, the virtualization and networking unit 110 requests local information pertaining to the object of interest from the metadata provision unit 120, and the metadata provision unit 120 forwards the request for the local information, whereby the local information pertaining to the object of interest may be acquired.

Here, the metadata provision unit 120 requests global information pertaining to the object of interest from the global information provision unit 130, and the global information provision unit 130 forwards the request for the global information, whereby the global information pertaining to the object of interest may be acquired.

Referring to FIG. 9, the virtualization and networking unit 110 may include a view space output unit 111, a view space analysis unit 112, an object-of-interest extraction unit 113, a virtual view network configuration unit 114, and a view network storage unit 115.

The view space analysis unit 112 may receive scenes 712, which contain objects 701 viewed through the glasses device in the physical domain.

The object-of-interest extraction unit 113 may extract objects that have been registered as objects of interest, or may newly register objects as objects of interest through an event 713 triggered by the eye gaze of a user.

Here, the object-of-interest extraction unit 113 may register a real object as the object of interest when the user gazes at the real object through the virtualization display device for a preset time AT (AT being a real number that is equal to or greater than 0).

Here, the glasses device and the objects of interest may form virtual entities 10 in the virtualized space.

The virtual entities 10 include a subject, which is a virtualized form of the glasses device, the objects of interest, and a virtual network, and the virtual view network configuration unit 114 may configure a single logical view network using the virtual entities.

The view network storage unit 115 stores the virtual subject, the objects of interest, and virtual network information therein, and the view space output unit 111 may finally output a scene for the virtualized space, which is output to a user through a view-based application service.

Referring to FIG. 10, the metadata provision unit 120 may include a view object image information provision unit 121, a view object location information provision unit 122, a view object network information provision unit 123, and a view object metadata provision unit 124.

The view object image information provision unit 121 may store and provide physical information and logical information about a subject and objects, scenes based on views recognized by the subject, and image information pertaining to the subject and objects of interest.

The view object location information provision unit 122 may store and provide information about the locations of the view-based objects.

The view object network information provision unit 123 may store and provide information about a communication network between the view-based objects.

The view object metadata provision unit 124 may store and provide metadata, including information about the attributes, performance, and functionalities of the subject and objects.

Referring to FIG. 11, the global information provision unit 130 may include a view data collection unit 131, a global view object search unit 132, a global view network generation unit 133, and a global information storage unit 134.

The view data collection unit 131 may collect information about the objects of interest in the local network configured in each local domain and information about a virtual network from a local metadata domain in order to run a view-based application service.

The global view object search unit 132 may update the metadata information pertaining to the objects of interest, collected from each local metadata domain, and global connection information using the most recent local information.

The global view network generation unit 133 may generate a global network for providing a view-based application service by connecting the view networks of the local domains.

The global information storage unit 134 may store the information about the objects of interest and the virtual network, collected from the view network in each local domain, the most recent metadata information related thereto, which is acquired from the global domain, and information required in order to configure a global network therebetween.

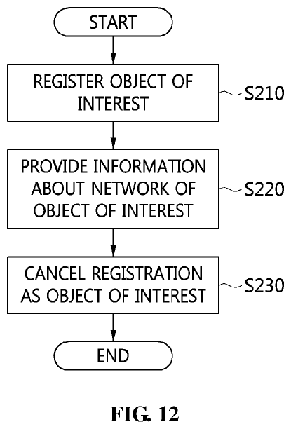

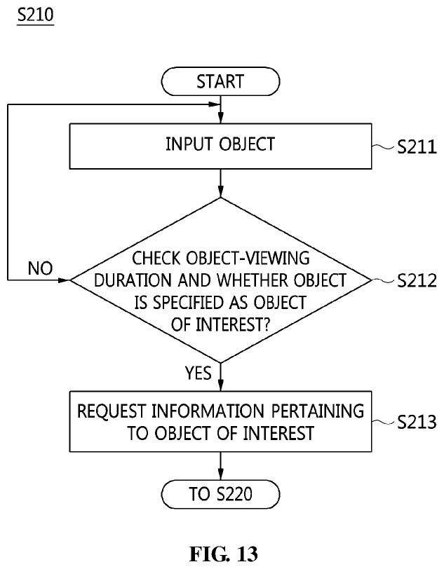

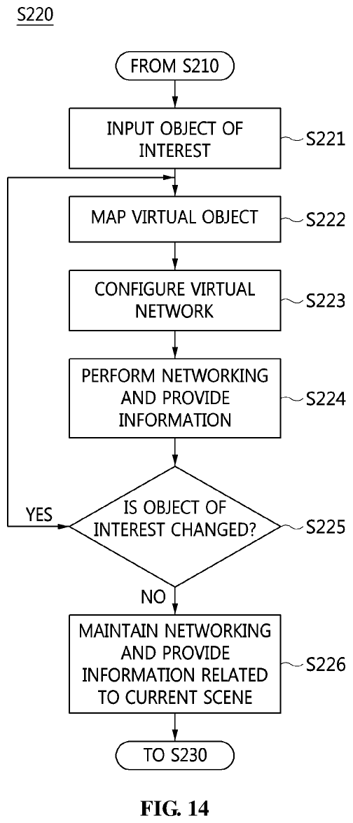

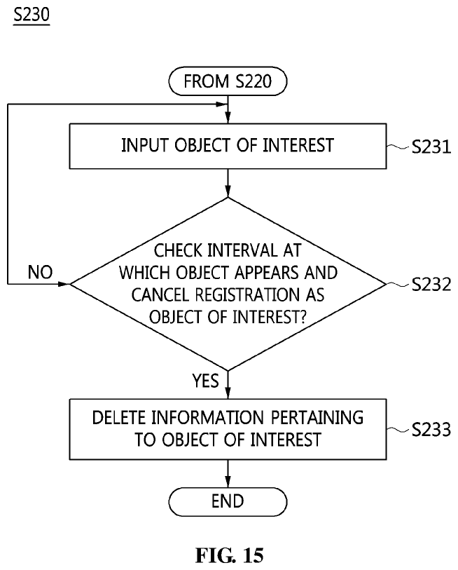

FIG. 12 is a flowchart that shows a method for object networking according to an embodiment of the present invention. FIG. 13 is a flowchart that specifically shows an example of the step of registering an object of interest illustrated in FIG. 12. FIG. 14 is a flowchart that specifically shows an example of the step of providing information about a network of objects of interest illustrated in FIG. 12. FIG. 15 is a flowchart that specifically shows an example of cancelling the registration as an object of interest illustrated in FIG. 12.

Referring to FIG. 12, in the object-networking method according to an embodiment of the present invention, first, an object of interest may be registered at step S210.

That is, at step S210, a real object included in a scene recognized by the virtualization display device of a user may be registered as an object of interest.

Referring to FIG. 13, at step S210, first, a real object may be recognized through the virtualization display device, and may then be input at step S211.

Here, at step S210, it may be determined at step S212 whether the real object is specified as an object of interest or whether a user gazes at the real object through the virtualization display device for a preset time AT (AT being a real number that is equal to or greater than 0).

That is, at step S212, when it is determined that the real object is an object that has been set as an object of interest in advance or that the user gazes at the real object through the virtualization display device for the preset time AT (AT being a real number that is equal to or greater than 0), information related to the object of interest may be requested at step S213. Also, when neither of the two conditions is satisfied, the process goes back to step S211, whereby a new object may be input.

That is, at step S213, the real object is registered as an object of interest, and network information is requested from the node that stores the network information, whereby virtualization and networking may be prepared.

Also, in the object-networking method according to an embodiment of the present invention, information about a network of objects of interest may be provided.

That is, at step S220, a virtual object may be generated for the object of interest, a virtual network for the virtual object may be generated, and information about the object of interest may be provided.

Referring to FIG. 14, at step S220, an object of interest may be input at step S221 in response to a request for network information made at step S210.

Also, at step S220, a virtual object corresponding to the object of interest may be generated and be mapped thereto at step S222.

Here, at step S222, at least one object of interest included in the current scene and the virtualization display device may be set as virtual entities of the scene.

Also, at step S220, a virtual network may be generated at step S223 using the virtual object.

Here, at step S223, a local network may be generated using local information pertaining to the object of interest.

Here, at step S223, a virtualized space corresponding to the current scene is generated, the virtual entities are set in the virtualized space, and a virtual network for the virtual entities set in the virtualized space is configured, whereby a local network may be generated.

Here, at step S223, the virtual entity is set by mapping the object of interest to a virtual object in a logical domain, and when the object of interest is not connected with a physical network, information about the virtual object may be provided to the virtualization display device using the virtual network connected with the virtual object in the logical domain.

Here, at step S223, the information about the virtual object may be transmitted by mapping the virtual object, corresponding to the object of interest, to a packet of interest using a Named-Data Networking (NDN) method related to Information-Centric Networking (ICN) in the network that connects the virtualization and networking layer with the local metadata layer.

Also, at step S220, networking of the objects of interest in the current scene may be performed and information thereabout may be provided at step S224.

Also, at step S220, whether the object of interest is changed in the current scene is checked. Here, when a new object of interest is input or when the object of interest disappears, steps S221 to S224 may be performed again, and when the object of interest is not changed in the current scene for a preset time AT (AT being a real number that is equal to or greater than 0), the network of objects of interest in the current scene is maintained, and information thereabout may be provided at step S226.

Here, at step S226, a global network including the object of interest may be generated by receiving the information about the network of the object of interest.

Here, at step S226, local information pertaining to the object of interest is requested from the local metadata layer, and when the local information is not present in a first node in the local metadata layer, which receives the request, the request for the local information is forwarded to a second node in the local metadata layer, whereby the local information pertaining to the object of interest may be acquired.

Here, at step S226, the local information pertaining to the object of interest may be updated.

Here, at step S226, the second node in the local metadata layer requests global information pertaining to the object of interest from the global repository layer, and when the global information is not present in a first node in the global repository layer, which receives the request, the request is forwarded to a second node in the global repository layer, whereby the global information pertaining to the object of interest may be acquired.

Here, at step S226, the global information pertaining to the object of interest may be updated.

Here, at step S226, a global network including the object of interest may be generated using the global information pertaining to the object of interest.

Also, in the object-networking method according to an embodiment of the present invention, registration as the object of interest may be cancelled at step S230.

That is, at step S230, the registration as the object of interest may be cancelled, whereby the corresponding object may be changed to an object not of interest.

Referring to FIG. 15, at step S230, first, whether the object of interest input through the virtualization display device is changed may be checked at step S231.

Also, at step S230, when the interval at which the object of interest appears in the scene is greater than a preset time AT (AT being a real number that is equal to or greater than 0), the registration as the object of interest may be cancelled, whereby the corresponding object may be changed to an object not of interest at step S232.

Here, at step S232, when a user cancels the registration as the object of interest for the scene, the registration may be cancelled, whereby the object may be changed to an object not of interest.

Here, at step S232, when the interval at which the object of interest appears in the scene is not greater than the preset time AT or when the registration of the object of interest is maintained, the process goes back to step S231, whereby whether the object of interest changes may be continuously checked.

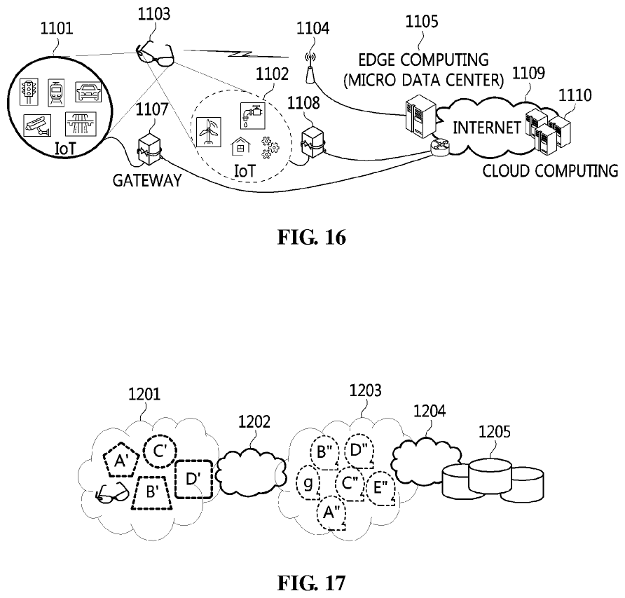

FIG. 16 is a view that shows an object-networking system that includes IoT devices as objects according to an embodiment of the present invention.

Referring to FIG. 16, objects viewed through a glasses devices 1103 are IoT devices, and the IoT devices and the glasses device 1103 are connected with the Internet.

Here, the objects in the scene 1101 and the objects in the scene 1102, which are viewed through the glasses device 1103, are connected with the Internet via respective gateways 1107 and 1108.

Here, the glasses device 1103 is connected with the Internet via an access point 1104.

FIG. 17 is a view that shows the process of providing local information (metadata information) in an object-networking system according to an embodiment of the present invention.

Referring to FIG. 17, a virtual network layer 1201 is an embodiment of the virtualization and networking layer illustrated in FIG. 6, a virtual network layer 1203 is an embodiment of the local metadata layer illustrated in FIG. 6, and a virtual network layer 1205 is an embodiment of the global repository layer illustrated in FIG. 6.

The virtualized objects A′, B′, C′ and D′, the virtual glasses, and the virtual network included in the virtual network layer 1201 may transmit and receive information about the attributes of the virtual objects, the virtual device, and the virtual network to and from the local metadata layer of the virtual network layer 1203. Here, the network 1202 connecting the virtual network layer 1201 with the virtual network layer 1203 may transmit and receive information therebetween by mapping a virtualized form of the object of interest to a packet of interest using a Named-Data Networking (NDN) method related to Information-Centric Networking (ICN). The network 1204 between the local metadata layer 1203 and the global repository layer 1205 may be configured using NDN. When NDN is not globally used, the network 1204 may be configured using TCP/IP.

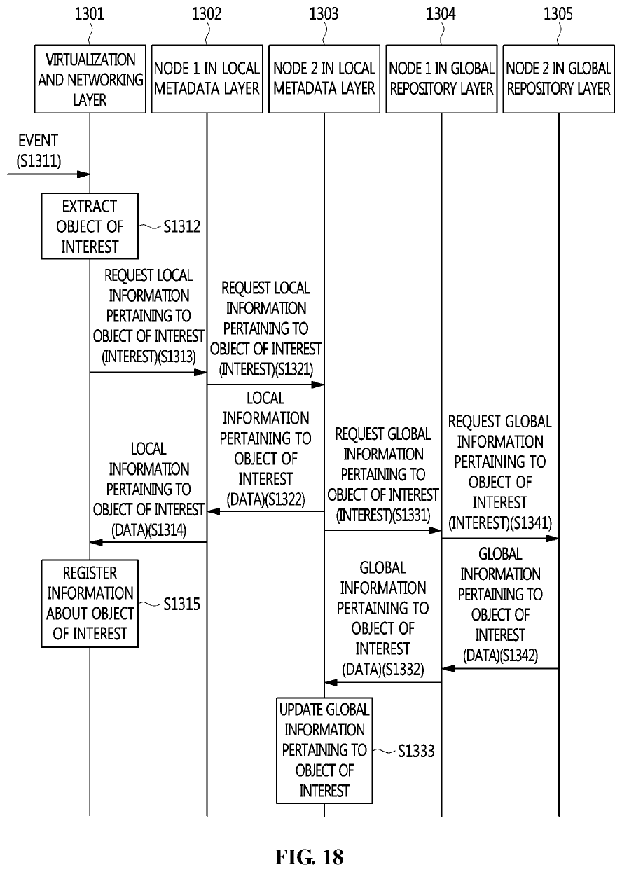

FIG. 18 is a sequence diagram that shows the process of acquiring local information and global information in an object-networking method according to an embodiment of the present invention.

FIG. 18 shows the process of acquiring local information and global information using a Named-Data Networking (NDN) method in an object-networking method.

A virtualization and networking layer 1301 may receive an event at step S1311 and extract an object of interest at step S1312.

The virtualization and networking layer 1301 may request metadata information, including image information of the object of interest, from a local metadata layer using NDN at step S1313 in order to acquire information about the extracted object of interest.

Here, the local metadata layer may include a plurality of network nodes 1302 and 1303, and when information about the object of interest is not present in the first node 1302 in the local metadata layer, a request message may be forwarded to the second node 1303, which is another network node in the local metadata layer, at step S1321.

The second node 1303 in the local metadata layer returns the information about the object of interest to the first node 1302 in the local metadata layer, and the first node 1302 in the local metadata layer may return the same to the virtualization and networking layer at step S1314.

Here, the acquired metadata may be registered as the information about the object of interest in the virtualization and networking layer 1301 at step S1315.

Meanwhile, the local metadata layer may request global information from a global repository layer.

Here, the second node 1303 in the local metadata layer may request the global information from a first node 1304 in the global repository layer at step S1331.

Here, when the global information pertaining to the object of interest is not present in the first node 1304 in the global repository layer, a request message may be forwarded to a second node 1305, which is another network node in the global repository layer, at step S1341.

The second node 1305 in the global repository layer may return the global information pertaining to the object of interest to the first node 1304 in the global repository layer at step S1342, and the first node 1304 in the global repository layer may return the same to the second node 1303 in the local metadata layer at step S1332.

Here, the second node 1303 in the local metadata layer may update global network information pertaining to the object of interest using the acquired information about the object of interest at step S1333.

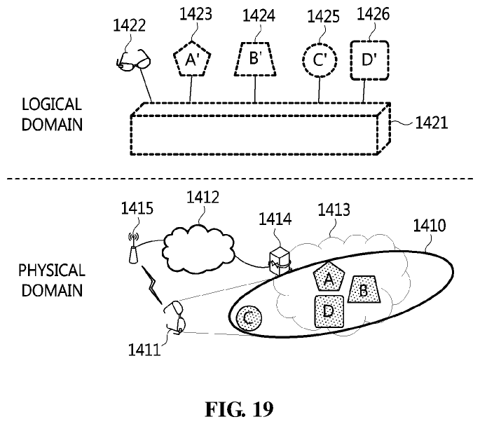

FIG. 19 is a view that shows the virtualization of a physical domain and the configuration of a virtual network according to an embodiment of the present invention.

FIG. 19 shows the virtualization of a physical domain and the configuration of a virtual network according to an embodiment of the present invention.

A physical domain includes physical objects 1413 connected with an IoT network, a glasses device 1411 connected with a wireless network (such as a mobile communication network, Wi-Fi, or the like), and a network 1412 that connects all of the physical objects and the glasses device. Because the network connected with the glasses device 1411 may be configured in a different manner from the network connected with the IoT objects, the network of the IoT objects is connected with a global network 1412 via a gateway 1414, and the glasses device 1411 is connected therewith via an access point 1415.

In the embodiment illustrated in the drawing, objects of interest included in the scene 1410 viewed through the glasses device 1411 are objects A, B, C and D, and the object C is not connected with the network 1413.

A logical domain is an embodiment for configuring a virtual network for the objects of interest included in the scene 1410 in the physical domain. The glasses device 1411 and the objects A, B, C and D in the physical domain are virtualized, whereby a virtual glasses device 1422 and virtual objects A′ 1423, B′ 1424, C′ 1425, and D′ 1426 are generated. The virtual glasses device 1422 and the virtual objects may be connected with the respective ports of a virtual switch 1421. Accordingly, the virtual glasses device 1422 and the virtual objects A′ 1423, B′ 1424, C′ 1425, and D′ 1426 may communicate with each other through the virtual switch. Here, in the virtual switch, the virtual glasses device 1422 and the virtual objects A′ 1423, B′ 1424, C′ 1425, and D′ 1426 may be connected with each other through a VLAN or VXLAN. In order to enable the virtual objects to communicate with the physical objects, the virtual switch 1421 may connect a physical port with the physical network 1412. Also, the virtual glasses device 1422 and the virtual objects 1423, 1424, 1425 and 1426 are mapped to the physical glasses device 1411 and respective physical objects, whereby communication may be performed such that the virtual domain matches the physical domain. Because the physical object C is not connected with the physical network, the virtual object C′ in the virtual network is not able to maintain the same attributes as the physical object C and is not able to physically communicate therewith. However, because a connection with the virtual network is made, information about the virtual object C′ may be provided to the physical glasses device. Also, when the physical object C is connected with the network 1413 in the future, all of the virtual objects and all of the physical objects for the scene 1410 may communicate with each other. Also, the physical object C may also be synchronized with the virtual object C′ 1425, like the other physical objects A, B and D synchronized with the virtual objects A′ 1423, B′ 1424 and D′ 1426.

Also, when the physical objects included in the scene are changed due to a scene change, a new object may be added to the virtual network in real time in order to match the changed scene, but there is no need to delete any of the virtual glasses device 1422 or the virtual objects connected with the virtual switch 1421 in real time. Accordingly, it is possible to quickly configure a network so as to match an instantly changed scene.

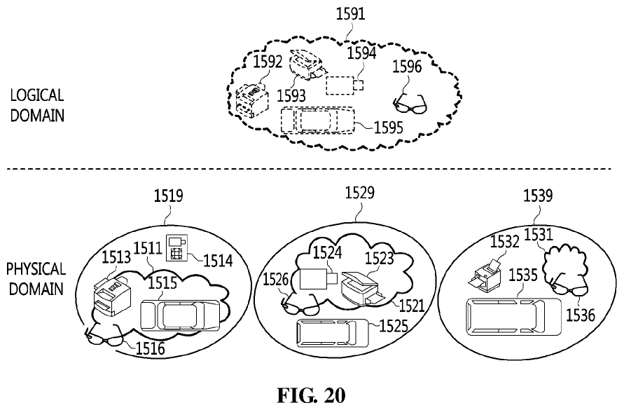

FIG. 20 is a view that shows the virtualization of a physical domain including physical objects having the same name and the configuration of a virtual network according to an embodiment of the present invention.

Referring to FIG. 20, among the objects included in the scene 1519 in a physical domain, the objects 1513 and 1515 are connected with the physical network 1511, but the object 1514 is not connected with the physical network 1511. In the logical domain therefor, a virtual network, which includes a virtual object 1592 (corresponding to the physical object 1513), a virtual object 1593 (corresponding to the physical object 1514), and a virtual object 1595 (corresponding to the physical object 1515), is configured so as to match the scene 1519.

Here, because the physical object 1514 is not connected with the network, synchronization and communication are not provided therefor, and only the attribute information thereof is provided to the glasses device 1516.

Also, among the objects included in the scene 1529, the objects 1523 and 1524 are connected with the physical network 1521, but the object 1525 is not connected with the physical network 1521. In the logical domain therefor, a virtual network, which includes the virtual object 1593 (corresponding to the physical object 1523), a virtual object 1594 (corresponding to the physical object 1524), and the virtual object 1595 (corresponding to the physical object 1525), is configured so as to match the scene 1529.

Here, because the physical object 1525 is not connected with the network, synchronization and communication are not provided therefor, and only the attribute information thereof may be provided to the glasses device 1526.

Also, among the objects included in the scene 1539, the objects 1532 and 1535 are not connected with the physical network 1531. In the logical domain therefor, a virtual network, which includes the virtual object 1592 (corresponding to the physical object 1532) and the virtual object 1595 (corresponding to the physical object 1535), is configured so as to match the scene 1539.

Here, because the physical objects 1532 and 1535 are not connected with the network, synchronization and communication are not provided therefor, and only the attribute information thereof may be provided to the glasses device 1536.

As shown in FIG. 20, because the virtual object in the logical domain is mapped to the object in the physical domain with a 1:N relationship (N being a natural number), a network for each scene may be configured in real time, and information thereabout may be provided also in real time. In the scenes 1519, 1529 and 1539, the physical glasses 1516, 1526 and 1536 may be the same glasses device.

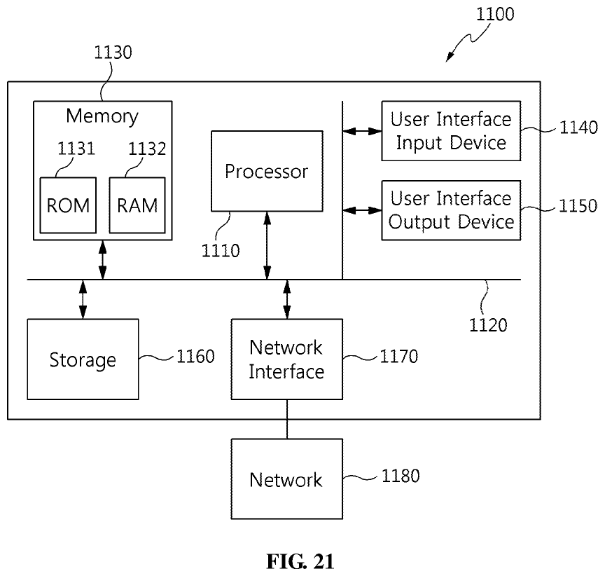

FIG. 21 is a view that shows a computer system according to an embodiment of the present invention.

Referring to FIG. 21, an object-networking apparatus 100 according to an embodiment of the present invention may be implemented in a computer system 1100 including a computer-readable recording medium. As shown in FIG. 21, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The object-networking apparatus 100 according to an embodiment of the present invention may include one or more processors 1110 and executable memory 1130 for storing at least one program executed by the one or more processors 1110. The at least one program may register a real object included in a scene recognized by the virtualization display device of a user as an object of interest, generate a local network using local information pertaining to the object of interest, and generate a global network including multiple objects of interest from the local networks of the multiple objects of interest using global information pertaining to the object of interest.

Here, the at least one program may set at least one object of interest included in the scene and the virtualization display device as virtual entities of the scene.

Here, the at least one program may generate a virtualized space corresponding to the scene, set the virtual entities in the virtualized space, and configure a virtual network for the virtual entities set in the virtualized space, thereby generating a local network.

Here, the at least one program may set the virtual entity by mapping the object of interest to a virtual object in the logical domain, and may provide information about the virtual object to the virtualization display device using the virtual network connected with the virtual object in the logical domain when the object of interest is not connected with a physical network.

Here, the at least one program may transmit the information about the virtual object by mapping the virtual object, corresponding to the object of interest, to a packet of interest using a Named-Data Networking (NDN) method related to Information-Centric Networking (ICN) in the network that connects a virtualization and networking layer with a local metadata layer.

Here, the at least one program may register a real object as the object of interest when the user gazes at the real object through the virtualization display device for a preset time AT (where AT is a real number that is equal to or greater than 0).

Here, the at least one program may cancel the registration as the object of interest and change the object to an object not of interest when the interval at which the object of interest appears in the scene is greater than a preset time AT (where AT is a real number that is equal to or greater than 0).

Here, the at least one program may request local information pertaining to the object of interest from the local metadata layer. When the local information is not present in a first node in the local metadata layer, which receives a request for the local information, the request for the local information may be forwarded to a second node in the local metadata layer, whereby the local information pertaining to the object of interest may be acquired.

Here, the second node in the local metadata layer may request global information pertaining to the object of interest from a global repository layer. When the global information is not present in a first node in the global repository layer, which receives a request for the global information, the request for the global information is forwarded to a second node in the global repository layer, whereby the global information pertaining to the object of interest may be acquired.

The present invention may configure a network between objects in augmented/virtual reality.

Also, the present invention may provide virtualization, networking, and configuration of the most recent information in order to deliver information about objects to a subject (user).

Also, the present invention may provide global information on objects, communication therebetween, real-time information related thereto, and an environment in which real-time interaction with the objects is possible.

As described above, the apparatus and method for object networking according to the present invention are not limitedly applied to the configurations and operations of the above-described embodiments, but all or some of the embodiments may be selectively combined and configured, so that the embodiments may be modified in various ways.

What is claimed is:

1. An apparatus for object networking, comprising:
one or more processors; and
executable memory for storing at least one program executed by the one or more processors,
wherein the at least one program registers a real object, included in a scene recognized by a virtualization display device of a user, as an object of interest, generates a local network using local information pertaining to the object of interest, and generates a global network of multiple objects of interest from local networks of the multiple objects of interest using global information pertaining to the object of interest.

2. The apparatus of claim 1, wherein the at least one program sets at least one object of interest included in the scene and the virtualization display device as virtual entities of the scene.

3. The apparatus of claim 2, wherein the at least one program generates a virtualized space corresponding to the scene, sets the virtual entities in the virtualized space, and configures a virtual network for the virtual entities set in the virtualized space, thereby generating the local network.

4. The apparatus of claim 3, wherein the at least one program sets the virtual entity by mapping the object of interest to a virtual object in a logical domain and provides information about the virtual object to the virtualization display device using a virtual network connected with the virtual object in the logical domain when the object of interest is not connected with a physical network.

5. The apparatus of claim 4, wherein the at least one program transmits the information about the virtual object by mapping the virtual object, corresponding to the object of interest, to a packet of interest using a Named-Data Networking (NDN) method related to Information-Centric Networking (ICN) in a network that connects a virtualization and networking layer with a local metadata layer.

6. The apparatus of claim 1, wherein the at least one program registers the real object, at which the user gazes through the virtualization display device for a preset time, as the object of interest.

7. The apparatus of claim 1, wherein the at least one program cancels registration as the object of interest and changes the real object to an object not of interest when an interval at which the object of interest appears in the scene is greater than a preset time.

8. The apparatus of claim 1, wherein the at least one program requests the local information pertaining to the object of interest from a local metadata layer and forwards a request for the local information from a first node in the local metadata layer, which receives the request for the local information, to a second node in the local metadata layer when the local information is not present in the first node, thereby acquiring the local information pertaining to the object of interest.

9. The apparatus of claim 8, wherein the second node in the local metadata layer requests the global information pertaining to the object of interest from a global repository layer and forwards a request for the global information from a first node in the global repository layer, which receives the request for the global information, to a second node in the global repository layer when the global information is not present in the first node in the global repository layer, thereby acquiring the global information pertaining to the object of interest.

10. A method for object networking, performed by an apparatus for object networking, comprising:
registering a real object, included in a scene recognized by a virtualization display device of a user, as an object of interest;
generating a local network using local information pertaining to the object of interest; and
generating a global network of multiple objects of interest from local networks of the multiple objects of interest using global information pertaining to the object of interest.

11. The method of claim 10, wherein generating the local network is configured to set at least one object of interest included in the scene and the virtualization display device as virtual entities of the scene.

12. The method of claim 11, wherein generating the local network is configured to generate a virtualized space corresponding to the scene, to set the virtual entities in the virtualized space, and to configure a virtual network for the virtual entities set in the virtualized space, thereby generating the local network.

13. The method of claim 12, wherein generating the local network is configured to:
set the virtual entity by mapping the object of interest to a virtual object in a logical domain; and
provide information about the virtual object to the virtualization display device using a virtual network connected with the virtual object in the logical domain when the object of interest is not connected with a physical network.

14. The method of claim 13, wherein generating the local network is configured to transmit the information about the virtual object by mapping the virtual object, corresponding to the object of interest, to a packet of interest using a Named-Data Networking (NDN) method related to Information-Centric Networking (ICN) in a network that connects a virtualization and networking layer with a local metadata layer.

15. The method of claim 10, wherein registering the real object as the object of interest is configured to register the real object, at which the user gazes through the virtualization display device for a preset time, as the object of interest.

16. The method of claim 10, further comprising:
cancelling registration as the object of interest,
wherein cancelling the registration as the object of interest is configured to cancel the registration as the object of interest and change the real object to an object not of interest when an interval at which the object of interest appears in the scene is greater than a preset time.

17. The method of claim 10, wherein generating the local network is configured to request the local information pertaining to the object of interest from a local metadata layer and to forward a request for the local information from a first node in the local metadata layer, which receives the request for the local information, to a second node in the local metadata layer when the local information is not present in the first node, thereby acquiring the local information pertaining to the object of interest.

18. The method of claim 17, wherein generating the global network is configured to request the global information pertaining to the object of interest from a global repository layer and to forward a request for the global information from a first node in the global repository layer, which receives the request for the global information, to a second node in the global repository layer when the global information is not present in the first node in the global repository layer, thereby acquiring the global information pertaining to the object of interest.
